(19) United States
(12) Patent Application Publication
(10) Pub. No.: US 2002/0181340 A1
(43) Pub. Date: Dec. 5, 2002

(54) Apparatus and method for simultaneous, independently operable read and write operations on a single laser-readable media disk

(76) Inventor: David William Bray, Austin, TX (US)

Correspondence Address: David G. Henry, 900 Washington Avenue, P.O. Box 1470, Waco, TX, 76701, US

(21) Appl. No.: 09/870,374

(22) Filed: May 29, 2001

(51) Int. Cl. G11B 7/00

(52) U.S. Cl. 369/30.19

(57) ABSTRACT

The invention is of systems and methods which facilitate simultaneous, independent, real-time or delayed, synchronous or asynchronous, recording to and playing from a digital video disc (DVD) or other disc recording medium, by utilizing separate sled assemblies and control mechanisms for one write/read equipment group and two read-only equipment groups, with each sled assembly capable of moving laterally across the entire horizontal disc recording surface without impeding the function of the other two sled assemblies.

### BACKGROUND OF THE INVENTION

1. Field of The Invention

The present invention relates to laser readable data disks or “digital data media” (CDs, DVDS, Video Disks, etc.) and mechanism for their recording and reading.

2. Background Information

The broadcasting of public events (sport, music, stage, etc.), whether video or audio, broadcast (television/radio) or narrowcast (internet) do not, by their nature, always conveniently lend themselves to interruptions at times most suitable or desirable to the broadcasters or their commercial underwriters. Forced, artificial interruptions have crept their way into all forms of broadcast events to accommodate the needs of advertisers, but often at the cost of compromising the quality, as applicable, of play or performance.

Sports events largely have adapted to telecast commercial interruption limitations by extending the length of time of pauses which would occur in the normal course of play, regardless of telecast considerations, rather than by adding artificial pauses by changing the rules of the game. Live theatrical and musical performances also have chosen not to add artificial pauses because they would detract from the enjoyment of the live performance by the attending theater audience. This has greatly limited live theatrical and musical telecast profitability (or their viability on a breakeven cost basis), except when underwritten without commercial pauses by corporations for telecast by PBS (Public Broadcasting System) or on the well-known “Hallmark Hall of Fame” major television network broadcasts.

Such situations put proprietors of sporting and performance events in a “Catch-22” between preserving the quality and attractiveness of the live performance for the live, paying audience while at the same time accommodating the requirements which are inherent in revenue-generating broadcast activities (commercial interruptions, most notably) Because of the limitations of current recording and play-back technology, every broadcast event tends to represent a compromise, or “least-worse” solution to this conflict.

Videotape equipment and filmmaking equipment both allow the recording/capturing and synchronization of audio and video sounds and images; however, the spooling of the tape or film renders impractical any search and retrieval of previously recorded segments, while recording of the even is still underway.

Technology for digitally-based Compact Discs (CDs) and Digital Video or Versatile Discs (DVDS) has progressed to allow the direct, real-time recording of sounds and images, without the need for the intermediate step of recording a negative disc for later duplications in positive format for playback. DVDs, depending on the type of digital compression standard and the recording format, offer the advantage of storing as much data as ten or more CDs, or up to several hours of quality images and sounds.

Despite their far reaching advantages over conventional video/audio tape technology, DVD apparatuses still do not provide a solution to the conflicting ideals of having only naturally occurring interruptions of play or performance for the live audience, on the one hand, and suitably interruptible play or performance for allowing insertion of advertisements directed to the broadcast audience, without loss of any portion of the event for this latter audience.

It would well serve those in the businesses of producing, underwriting and telecasting public events to provide some means by which broadcast events need not be artificially interrupted or extended to accommodate commercial interruptions, while at the same time allowing broadcast underwriters considerable flexibility in inserting advertisements without loss of event segments to the broadcast audience. A laser-readable media system which would serve such needs would be one which allowed for simultaneous, independently-actuated, synchronous or asynchronous, continuous or non-continuous recording and decoding of a live event.

### SUMMARY OF THE INVENTION

It is an object of the present invention to provide an apparatus both for recording and reading laser-readable digital media which apparatus allows simultaneous and independently actuated recording and playback of previously recorded video and/or audio segments.

It is another object of the present invention to provide a method for broadcasting live events (“time sequential events”) which allows for non-interrupted performance or play at the live event, yet facilitates the broadcast of the full event (substantially in real time, and before the event is concluded) with inserted advertisements or other desired insertions to be viewed by a broadcast audience.

The present invention satisfies these objects. As a time sequential event (play of sport or performance of some nature) begins in real-time, the apparatuses of the present invention allow for continuous recording of the event. At points determined by mutual agreement between the producing agency and the telecaster, the broadcast of the performance is interrupted (but not the event itself) while advertisement(s) are aired, but while the recording onto DVD (or suitable alternatives) continues. At the conclusion of inserted advertisement or announcement, the independently actuatable DVD playback features of the present systems are actuated to play the recorded event from point of the commercial interruption (as recorded during the interruption) until the next interruption.

The DVD-centered systems of the present invention use individual, separate sled assemblies—one for the write function (with a read capability for local or studio output only), and two for read functions to output for mass transmission. This arrangement allows immediate switching to a replay from an early performance segment at the outer edge of the disc by one read sled assembly, while the write sled assembly functions to record the final segments of the live performance on the innermost portion of the disc with the second read sled assembly positioned nearby to resume playing immediately after the final segments of the live performance at the conclusion of the replay of the early performance segment by the first read sled assembly.

Use of the present systems allows a live audience to enjoy a performance or sporting event without artificial interruption, while the broadcast audience will the performance in its entirety, albeit with time-lags due to pauses and commercial insertions. An exemplary application of the present invention involves soccer. Soccer is telecast and played to worldwide rules in 45 minute halves with no regularly scheduled pauses in play of sufficient length to accommodate commercial insertion. The systems and method of the present invention would allow normal play, as viewed by the live audience, yet permit suitably profitable interruptions for broadcasters, without loss of any portion of the games for the broadcast audiences.

Additionally, the present invention, in a slightly different configuration, allows continued recording of the live performance and unlimited, simple and repeated “instant replay” of the telecast performance action from a single apparatus, rather than from multiple videotape machines. This application involves the use of multiple event cameras (“input means”) connected to individual, dedicated systems of the present invention, in order to capture a complete record of the event performance.

### BRIEF DESCRIPTION OF THE DRAWINGS

FIG. 1 is a top plan view block diagram of a DVD player according to the present invention, including a write drive sled assembly and two read drive sled assemblies.

### DETAILED DESCRIPTION OF THE PREFERRED EMBODIMENT

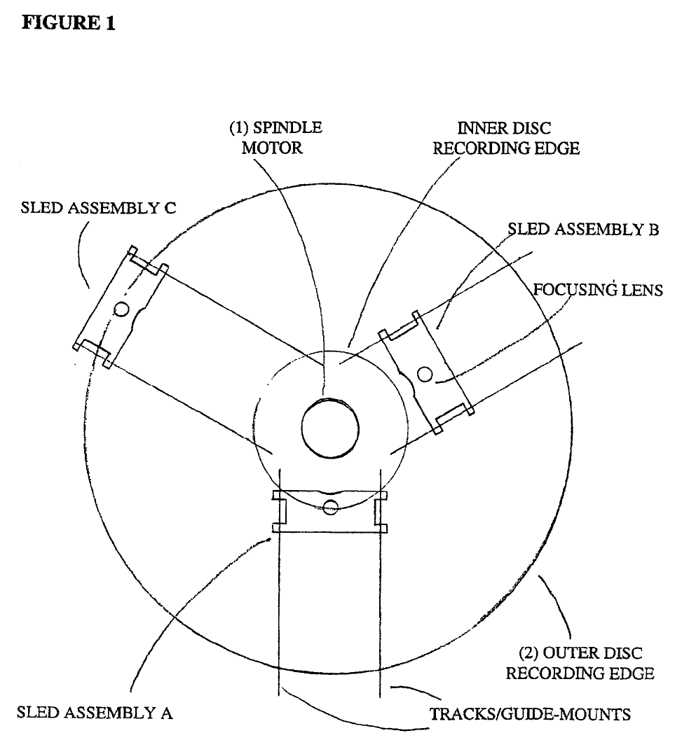

Referring to FIG. 1, systems of the present invention improve upon current recording and playback of DVDs by utilizing physically separate recording and playback/reading mechanisms.

The writing/recording mechanism is positioned on its own sled, and two reading/playback mechanisms are positioned on separate sleds. The sleds each have their own tracks or guides, which are offset vertically and/or horizontally so as for one sled not to interfere with movement of the other sleds by either physical contact or track vibration.

FIG. 1 shows from a top view a CD or DVD write/read drive and a disc's outer edge (1), and the spindle-motor assembly (2) which rotates the disc resting atop it. All three sled assemblies are positioned beneath the disc. Sled assembly A contains the recording mechanism for writing to the disc, and, in the preferred embodiment of the present invention, a reading mechanism for the immediate reading of the information upon writing to the disc; however, a reading mechanism on sled assembly A is not necessary for the present invention to perform, as all output for mass transmission will be read by either sled assemblies B or C. Sled assembly B contains the primary playback/reading mechanism, and sled assembly C contains the secondary (or replay) playback/reading mechanism. The preferred embodiment of the present invention has the focusing lens of each sled assembly positioned horizontally 1200 apart from the other sled assemblies; however, it is only necessary that the sled assemblies be positioned sufficiently apart so as for one not to interfere with the functioning of the other two.

Sled assembly A is closest to the center of the disc, and is nearing the completion of recording the multi-hour event. Sled assembly B is not as close to the center of the disc as sled assembly A, because the playback/reading of the recorded event has been paused many times to insert commercials into the telecast. Sled assembly C is positioned near the outer edge of the disc, as it is poised to playback a highlight from very early in the recording of the event.

The preferred embodiment of the present invention further utilizes DVD standard industry components. On sled assembly A, this would involve a focusing lens directed at the disc by an electo-mechanical actuator, a laser to generate a light beam through the lens for reflection back to a photo-detection system on the sled in order to allow read capability. As noted earlier, it is not necessary for sled assembly A to have a photo-detection system for read capability. Sled assemblies B and C must have a photo-detection system, as well as the other components on sled assembly A.

Each sled is connected (not shown) to standard industry DVD write and read electronics circuitry (“reading control means” and “writing control means”), which send and receives signal to and from the sled assemblies in order to direct their operational movement, send data to be written, and receive data that has been read. In the preferred embodiment of the present invention, each sled will have its own electronics circuitry; however, a single circuitry group sufficiently sophisticated to operate all of the sled assemblies may be used.

The electronics circuitry connected to the sled assemblies is further connected to processing electronics which allow multiple data inputs to accommodate multiple cameras and/or microphones in the production of the event telecast. The data inputs would be encoded in a desired format, such as the video compression standard MPEG. The input data blocks then would be sent to the electronics circuitry and on to sled assembly A for writing to the disc. The electronics circuitry would address the data blocks as they are written to the disc, and keep track of the addressing for further referencing.

When commanded to read, sled assemblies B or C would move across the disc to the address relayed by the electronics circuitry (or re-focus the lens if in immediate proximity to the address, as is always the case with sled assembly A), read the specified data block locations on the disc and send a data signal back through the electronics circuitry for decoding into an uncompressed signal for direct output to a display or for additional modification for mass transmission means.

Each sled assembly, via the electronics circuitry, would have its own control panel with a display panel showing the address of the current write/read location and the time to a precision of hundredths of seconds of that location beginning at Time Zero at the start of recording and counting upward. The control panel would include “start”, “stop”, “pause”, “seek forward” and “seek backward” functions, as well as an input panel to designate a recorded segment by precise time and/or storage address. Additionally, the control panel for the write/read sled assembly A will display the input data source of the data being written to the disc.

Using a separate sled assembly for each functional role allow the one read assembly to be paused or positioned to begin playback during the operation of the other read assembly, such that playback begins or resume in at or less than the time required for the disc to complete one revolution. This immediate “cuing” feature is very important for seamless switching of segments during the telecast, and avoids dead-time waiting for a sled assembly to move across the surface of the disc during a “long-seek”search to a particular segment of the recorded event.

The write/read sled assembly A equipment mechanism operates in industry “normal” recording mode, which is to write and to address audio and/or video data to the disc sequentially to adjacent data blocks, without leaving intentional gaps between data blocks. The read equipment mechanism on sled assembly A outputs data only to a local or studio monitor and/or speaker, so the event producer, director, engineer and/or technician can see and/or hear what just has been written to the disc.

Recording in normal mode allows the read-only equipment of sled assemblies B and C (as well as A) to operate in industry “normal” read mode, which is to decode and playback audio and/or video data from sequentially-addressed, adjacent data blocks. In both normal write and read modes, the sled assemblies progress smoothly across the face of the disc, without moving haltingly in starts, stops or rapid changes of pace.

The configuration of a particular embodiment of the present invention will vary according to the desired functionality of the system at any given instance. As a DVD device used in broadcasting time sequential events, with a system of the present directly outputting for broadcast camera and/or microphone data feeds as selected by the studio producer, director or technician, the preferred write and read format method is DVD-R. In DVD-R, a disc can be recorded only once. This would preserve a permanent copy of the telecast as it was transmitted to a mass audience.

As a DVD device used to capture the images and/or sounds from a single camera and/or microphone among many used to telecast an event, the preferred digital media is exemplified by DVD−RW or DVD+RW. In either DVD−RW or DVD+RW, a disc can be recorded and then re-written with new video and/or audio data multiple times. Using either DVD−RW or DVD+RW for single camera and/or microphone feeds of an event reduces the overall cost by allowing discs to be rewritten if so desired when used for future events. DVD−RW and DVD+RW are standards backed by different electronics manufacturers, and offer varying compatibility with existing DVD playing machines available to consumers and for industrial applications. Embodiments of the present invention, regardless of the digital media format, would also be configurable to a variety of video image and audio recording compression standards, such as MPEG.

The present invention represents a new and unobvious compilation of existing technologies and apparatuses. While each component of a system which is assembled according to the present invention is certainly drawn from prior art, the present assemblage is unknown, and the needs met thereby have as yet been unsatisfied. In view of the advantages provided through practice of the present invention, together with their not having been provided before, the present assemblage is self-evidently not an obvious combination of the individual components or steps of the prior art.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An improved An apparatus for recording and reading digital media comprising:
digital media support means for supporting a digital media member during use;
writing means for recording digital data representative of a time sequential event onto said digital recording media;
first reading means for first reading said digital data on said digital recording media;
recording control means for actuating said writing means to record said digital data as generated from input means during said time sequential event;
first reading control means for actuating said first reading means, independently of said recording control means and of said recording means, for first reading a portion of said digital data as previously recorded by said writing means during operation of said writing means.

2. The system of claim 1 further comprising:
second reading means for reading said digital data on said digital recording media;
second reading control means for actuating said second reading means, independently of said recording control means, of said recording means, or said first reading means, and of said first reading control means, for second reading a portion of said digital data as previously recorded by said writing means during operation of said writing means.

3. A method for broadcasting a time sequential event comprising the steps of:
selecting a digital media recording a playback system comprising:
digital media support means for supporting a digital media member during use;
writing means for recording digital data representative of a time sequential event onto said digital recording media;
first reading means for first reading said digital data on said digital recording media;
recording control means for actuating said writing means to record said digital data as generated from input means during said time sequential event;
first reading control means for actuating said first reading means, independently of said recording control means and of said recording means, for first reading a portion of said digital data as previously recorded by said writing means during operation of said writing means;
attaching said input means to said system;
actuating said recording control means for digitally recording data from said input means;
attaching said system to means for transmitting said digital data to broadcast means and actuating said broadcast means;
de-activating transmission of said digital data from said system to said broadcast means for a first period for transmission of material other than as represented by said digital data;
after said first period, actuating said first reading control means for transmitting to said broadcast means said digital data beginning substantially at a first resumption point of said digital data as represents that portion of said time sequential event that was interrupted upon said de-activation of said broadcast means.
